(19) United States
(12) Patent Application Publication
(10) Pub. No.: US 2016/0340573 A1
(43) Pub. Date: Nov. 24, 2016

(54) SYSTEM AND METHODOLOGY FOR WELL TREATMENT

(71) Applicants: Sergey Vladimirovich Semenov, Kurgan (RU); Schlumberger Technology Corporation, Sugar Land, TX (US)

(72) Inventors: Sergey Vladimirovich SEMENOV, Kurgan (RU); Mohan PANGA, Katy, TX (US); Michael TOUGH, Katy, TX (US); Mathew SAMUEL, Sugar Land, TX (US); Andrey Vladimirovich YAKOVLEV, Primorsk (RU); Danil Sergeyevich PANTSURKIN, Novosibirsk (RU); Salvador AYALA, Houston, TX (US); Geza HORVATH-SZABO, Novosibirsk (RU); Sergey Sergeevich SKIBA, Novosibirsk (RU)

(21) Appl. No.: 15/112,158

(22) PCT Filed: Jan. 17, 2014
(86) PCT No.: PCT/RU2014/000023

§ 371 Date: Jul. 15, 2016

(51) Int. Cl. C09K 8/80; E21B 43/26; E21B 43/267; C09K 8/62; C09K 8/92

(52) U.S. Cl. CPC C09K 8/80; C09K 8/62; C09K 8/92; E21B 43/267; E21B 43/26

(57) ABSTRACT

A technique facilitates a well treatment, such as a well stimulation. The technique comprises injecting a gel containing proppant into a wellbore extending into a subterranean formation. Additionally, a low viscosity fluid is injected into the wellbore with the gel either simultaneously or separately. An additive or additives may be used to maintain the gel in the low viscosity fluid. The technique further comprises separating the gel into slugs and then causing the slugs to flow into fractures in the subterranean formation.

### BACKGROUND

Hydraulic fracturing is a well stimulation technique in which fractures are created in a subterranean formation. The fractures are created by injecting fluid with a pressure which is higher than the fracturing pressure of the formation. The injected fluid carries a proppant which is placed in the fracture to prevent closure of the fracture when the pressure is released at the end of the stimulation treatment. Highly viscous fluids often are used to transport the proppant from the surface, down into the wellbore, and out into the fractures. The viscosity of the fluid reduces the sedimentation rate of the proppant so that a higher portion of the injected proppant is delivered to the intended location in the fractures. Low viscosity fluids, e.g. slick water, are sometimes used in tight formations such as shales or tight sands. However, in low viscosity fracturing fluid treatments, prevention of proppant sedimentation can be challenging. Existing techniques also present challenges in transporting proppant into secondary and tertiary fractures of complex fracture networks.

### SUMMARY

In general, a technique is provided for facilitating a well treatment. The technique comprises injecting a gel containing proppant into a wellbore extending into a subterranean formation. Additionally, a low viscosity fluid is injected into the wellbore with the gel either simultaneously or separately. An additive or additives may be used to maintain the gel in the low viscosity fluid and/or to prevent proppant laden gel slugs from settling. In some applications, other additives may be used to prevent disintegration of the gel slugs to their constituents. The technique further comprises separating the gel into slugs and then causing the slugs to flow into fractures in the subterranean formation.

However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is a schematic illustration of an example of a well treatment system, according to an embodiment of the disclosure;

FIG. 2 is a schematic illustration of a slug which may be carried downhole and out into a fracture to facilitate a well treatment, according to an embodiment of the disclosure;

FIG. 3 is a schematic illustration of a porous material containing air or other gas, or liquid with a density lower than the density of water, to improve slug buoyancy, according to an embodiment of the disclosure;

FIG. 4 is a schematic illustration of a plurality of slugs containing proppant and carried by a clean fluid, such as slick water, according to an embodiment of the disclosure;

FIG. 5 is a schematic illustration of a cell used in testing shear stability of the proppant containing slugs, according to an embodiment of the disclosure;

FIG. 6 is a graphical representation of data comparing the amount of separated proppant after application of shear stress on the slugs, according to an embodiment of the disclosure;

FIG. 7 is a graphical representation similar to that of FIG. 6 but showing the effects of an additive, according to another embodiment of the disclosure;

FIG. 8 is a table illustrating the impact of pH on the temperature at which certain gel materials can be cross-linked, according to an embodiment of the disclosure;

FIG. 9 is a graphical representation of data showing settling rates of proppant laden slugs having different proppant concentrations, according to an embodiment of the disclosure; and

FIG. 10 is a schematic illustration of an example of an equipment layout for delivering fracturing fluid downhole into a wellbore, according to another embodiment of the disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

The present disclosure generally relates to a system and methodology for performing a well treatment. A gel with proppant is injected into a wellbore extending into a subterranean formation. Additionally, a clean fluid, e.g. a low viscosity fluid, is injected into the wellbore. The low viscosity fluid and the gel may be injected simultaneously or separately. An additive or additives may be used to maintain stability of the gel in the low viscosity fluid. In some applications, additives may be used to increase the buoyancy of the gel and/or to prevent the disintegration of the gel to its constituents. The technique further comprises separating the gel into slugs and then causing the slugs to flow into fractures in the subterranean formation. In some embodiments, the gel may be separated into slugs at a downhole location. The downhole location is a location downstream of high-pressure frac pumps used to deliver the low viscosity fluid and the gel into the wellbore.

In an embodiment, the well treatment comprises injecting a cross-linked gel containing proppant into a wellbore extending into a subterranean formation. A low viscosity fluid also is injected into the wellbore either simultaneously or separately from the cross-linked gel. The low viscosity fluid and cross-linked gel also can be injected in portions, one after another, starting with either substance. Such a process can be repeated as many times as desired and various volumes of the portions may be used. In some applications, a cross-linking additive may be added to the gel intermittently during injection of the gel and the low viscosity fluid to create independent, cross-linked slugs. In some applications, the cross-linked gel is separated into slugs at a downhole location. Additionally, at least one specified parameter of the low viscosity fluid is adjusted to limit breakdown of the slugs, i.e. to limit disintegration of the slugs into their constituents. For example, the pH of the low viscosity fluid may be adjusted and/or a concentration of cross-linking ions in the low viscosity fluid may be adjusted. The low viscosity fluid and the slugs are placed under pressure into fractures formed in the subterranean formation, thus distributing the slugs to form proppant support members, such as pillars. Pillars are consolidated proppant packs positioned between opposing fracture walls of a fracture to hold apart the fracture walls.

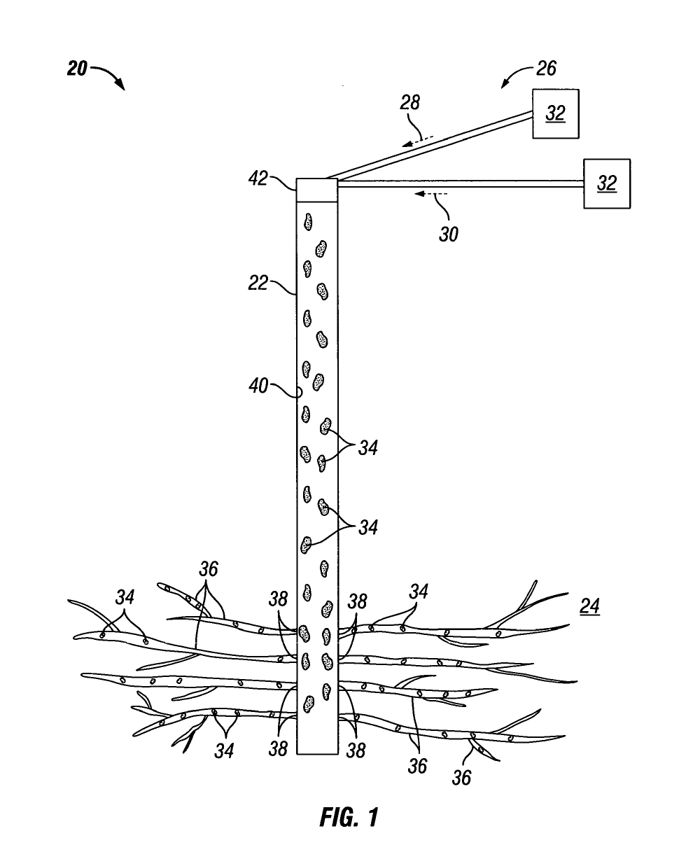

Referring generally to FIG. 1, an embodiment of a well system 20 is illustrated as comprising a wellbore 22 extending into a subterranean formation 24. The wellbore 22 may comprise a vertical wellbore and/or a deviated wellbore, e.g. a horizontal wellbore. In this example, a well treatment injection system 26 is employed to inject a gel 28, e.g. a cross-linked gel, and to inject a low viscosity fluid 30, e.g. slick water, downhole into wellbore 22 via high-pressure pumps 32, such as high-pressure frac pumps. In some applications, the gel 28 and the low viscosity fluid 30 are mixed before they enter the wellbore 22.

The well treatment injection system 26 separates the gel 28 into slugs 34 which flow with the low viscosity fluid 30 under pressure into fractures 36 extending into the subterranean formation 24. By using the combination of gel slugs 34 and low viscosity fluid 30, the slugs 34 are distributed throughout the fractures 36, including into secondary and tertiary fractures. The gel slugs 34 may be used to ultimately form pillars along the fracture which help prop open the fracture. The slugs 34 form independent, proppant support members which hold open the fractures 36 while increasing conductivity. The gel 28 may be separated into relatively small slugs 34 via shearing as the gel 28 passes through perforations 38 formed through a casing 40 lining wellbore 22. For example, larger slugs 34 may be sheared into smaller slugs 34 at perforations 38. However, a variety of techniques may be used to separate the gel stream into slugs downstream of the high-pressure frac pumps 32. For example, a device 42, e.g. a valve, may be positioned in the flow path of gel 28 and cycled to create the slugs 34. In some applications, a cross-linking additive may be added to the gel stream intermittently to create the independent cross-linked slugs 34. For example, the device 42, e.g. valve, may be designed to intermittently add cross-linker to gel 28 to create the independent slugs 34 within the injected fluid.

However, the well treatment may utilize a variety of high and low viscosity fluids, additives, pressures, and/or slug formation techniques to facilitate creation of slugs 34 which ultimately become proppant support members, e.g. pillars, in subterranean fractures. For example, various additives may be used to create buoyant slugs 34 or partially buoyant slugs 34 of proppant suspended in a clean fluid, which can be a high or low viscosity fluid depending on the application. The “clean fluid” refers to the fluid which does not contain proppant particulates before it passes wellhead/device 42, and “dirty fluid” assumes a quantity of proppant, e.g. sand, dispersed and held inside of a fluid, e.g. gel 28, to create the slugs 34. The dirty fluid is different from the clean fluid, e.g. low viscosity fluid 30, and immiscible or partially miscible with the clean fluid for a period. As illustrated in FIG. 2, the dirty fluid may be used to create individual slugs 34. In this example, each slug 34 is formed from dirty fluid comprising a cross-linked gel 28 containing a proppant 44 and an additive 46, e.g. a light weight buoyancy controlling additive, to provide the slugs 34 with increased buoyancy (decreased specific gravity) in the low viscosity fluid 30.

The low viscosity clean fluid 30 may comprise a variety of fluids, such as slick water, water, emulsions, oil, or other fluids which have an apparent viscosity within the 0.3-100 cP range measured at 100 sec⁻¹ shear rate and at 25° C. In some applications, the clean fluid 30 may be a higher viscosity clean fluid, such as VES-based fluids, polymer containing fluids, foamed fluid, energized fluids, acid, other polymer or surfactant-based fluid, high solid content fluid, or other fluid which has an apparent viscosity within the 10-10,000 cP range measured at 100 sec⁻¹ shear rate and at bottomhole conditions. The dirty fluid 28, e.g. gel, used to create slugs 34 containing proppant 44 has properties which are different from the properties of clean fluid 30, and the dirty fluid 28 is immiscible or partially miscible with the clean fluid 30 for a period due to, for example, cross-linked structure of the dirty fluid, differences in their viscosities, hydrophobic/hydrophilic properties, formation of emulsions, yield stresses, and/or other properties. The clean fluid 30 also may contain additives which promote transport of the slugs 34 while reducing settling of the proppant 44. Examples of suitable additives include fibers, viscosifying additives, yield stress altering additives, wetting agents, or various combinations of additives.

Referring again to FIG. 2, the illustrated buoyant or partially buoyant slugs 34 may have a specific gravity in the range of from 0.7 to 2.0 and can be created by inclusion of the proppant 44 mixed with the buoyancy controlling additive 46 inside cross-linked gel 28. In at least some applications, the specific gravity of the slugs 34 may be lower than the specific gravity of the proppant. The additive 46 may comprise a variety of materials which have specific gravity less than the specific gravity of the proppant 44 at, for example, pressures of at least one bar and temperatures of at least 0° C. By way of example, the buoyancy additive 46 may comprise air, N₂, CO₂, CH₄, C₂H₆, natural gas, and/or other gases, including mixtures of gases. The additive 46 also may comprise liquid immiscible or partially miscible with water including oil (natural oil, diesel oil, vegetable oil, palm oil), gasoline, organic solvents (benzene, toluene) and other suitable liquids, including mixtures of liquids. Furthermore, the additive 46 may be in the form of solid particles, e.g. hollow glass or ceramic spheres or other particles, hollow fibers, wood pieces, plastic particles, porous particles (fly ash, plastic foams, porous coal, carbon black, artificial porous particles and other suitable particles) having gas (e.g. air, N₂, CO₂, CH₄, C₂H₆, and/or natural gas), or liquid immiscible or partially miscible with water including oil (e.g. natural oil, diesel oil, vegetable oil, palm oil), gasoline, organic solvents (e.g. benzene, toluene), and other suitable liquids, including mixtures of liquids, in the pores, and/or clathrate compounds (gas hydrates). These types of buoyancy controlling additives also may be used simultaneously and/or in various combinations. In some applications, the dirty fluid used to create slugs 34 may not contain light weight additive 46 if, for example, the cross-linked gel 28 provides enough buoyancy.

Concentrations of both proppant 44 and additive 46 in the buoyant slugs 34 can be varied substantially from one application to another. From an operational standpoint, the concentration (e.g. 0-30 lbm/gal of fluid, which represents resulting mixture of clean fluid and dirty fluid) may be selected to promote a desired buoyancy and/or flowability of the slugs 34 driven by the clean fluid 30, e.g. low viscosity fluid. The liquid/solid substance which binds proppant 44 and buoyancy controlling additive 46 to maintain slugs 34 can be referred to as a supporting matrix. For example, the supporting matrix may comprise gel 28 with or without various additives. In this example, proppant 44 is a separate constituent which may be added to the supporting matrix. Depending on the application, the slugs 34 may comprise a mixture of various components, including the supporting matrix/gel 28, proppant 44, light weight buoyancy controlling additive 46 to reduce the specific gravity, and other additives 46, such as surfactants, clay stabilizers, breakers, and/or other suitable additives for a given application. The slugs 34 and the clean fluid 30 are pumped together into the subterranean formation 24 at a pressure and rate sufficient to create at least one fracture in the subterranean formation 24.

The combination of clean fluid 30, e.g. low viscosity fluid, and the slugs 34 enhances the well treatment application. For example, because of both improved transport properties and low settling rate, the buoyant or partially buoyant slugs 34 overcome the problem of proppant transport that is experienced in the traditional “low viscosity” fracturing treatments. Also, usage of buoyant or partially buoyant slugs 34, having cross-linked gel, for fracturing treatments can decrease the amount of consumed guar or other viscosifying polymer due to improved transport properties, thus avoiding use of high viscosity fluids to transport the propping agents to the fracture. The use of buoyant or partially buoyant slugs 34 also can reduce the amount of viscosifying agents used for the clean fluid, e.g. slick water, foamed fluid, energized fluids, acid, or other polymer or surfactant based fluid. The present technique further enables delivery of high proppant concentrations that would otherwise be impossible with traditional slick water treatment. High proppant concentrations can be readily used in the slugs 34 when the specific gravity of the slug is compensated by the addition of the light weight additive 46 to make the slug 34 buoyant or partially buoyant.

Additionally, the methodology described herein enables substantial increasing of the propped area of the fracture due to reduced settling of proppant laden slugs 34, thus resulting in increased production rates from the reservoir/subterranean formation 24. The methodology also enables use of proppant 44 with large mesh size (e.g. 12/20, 16/30, and other large sizes) which could not otherwise be used with traditional slick water treatment due to low viscosity of the slick water and due to bridging issues. Furthermore, the methodology described herein provides enhanced fracture conductivity for the entire fracture due to proppant distribution and the presence of the open channels between the placed slugs 34. The described approach further enables creation of a complex fracture network similar to traditional slick water treatment but with the enhanced transport of proppant into the secondary and tertiary fractures.

Buoyant or partially buoyant slugs 34, as described herein, may be used for many types of hydraulic fracturing operations, including frac operations, frac and pack operations, and other fracturing operations. The methodology also may be employed in many types of subterranean formations 24, including sandstone, shale, carbonate, and/or other types of subterranean formations. Similarly, the methodology may be used in many types of wells, including deviated, e.g. horizontal, and vertical wells used in various reservoirs, e.g. oil, gas, wet gas, coal bed methane, gas condensate, and/or other types of suitable reservoirs.

The gel 28 may be used to create a supporting matrix able to integrate the ingredients of the slugs 34. For example, the gel 28 may serve as a supporting matrix by creating the gel with a viscosity several orders of magnitude higher than the viscosity of the clean or low viscosity fluid 30. Examples include the usage of a cross-linked gel or other suitable gel. However, other techniques may be used to create the supporting matrix, such as techniques which create a rigid matrix, e.g. fibers, having the capacity to carry the proppant 44 and the additive 46. According to another approach, the supporting matrix can be created by using light, porous materials which can act both as supporting matrix and as the light weight buoyancy controlling additive 46 at the same time. Such additives also may be added to the gel 28.

In another embodiment, the gel/supporting matrix utilizes a creation of a viscoelastic supporting matrix with yield stress. In this latter medium, the proppant particles 44 and light weight buoyancy controlling additive particles 46, e.g. droplets or bubbles, do not segregate because their radii are below certain limits. The limiting radii depend on the yield stress of the medium as well as the densities of the supporting matrix and the inclusions. In another example, the supporting matrix represents fluid which does not have the yield stress but the viscosity of the supporting matrix is sufficiently high. Although segregation, e.g. sedimentation and creaming, of the proppant 44 and light weight buoyancy controlling additive 46 may occur in this latter example, the separation is negligible on the timescale of fracture closure.

The buoyancy controlling additive 46 may comprise a variety of materials having a specific gravity lower than the specific gravity of the proppant 44. Examples of the buoyancy controlling additive 46 comprise cenospheres, rubber particles, wood chips, nut shells, tree barks, seeds, microspheres, ceramics, polymeric particles, glass beads, glass bubbles, fibers, hollow fibers and other particles, fly ash, ash from vegetable origin, air trapped pet coke, blown perlite, blown asphalt, blown glass, plastic foams, gelled oils, clathrates comprising gas hydrates, gas, hollow spheres formed of glass or ceramic, and blends of these additives. Additionally, the specific gravity of the buoyancy controlling additive 46 may be lower than 1.0 to provide buoyancy of the slugs 34 or to at least reduce their effective specific gravity. The added buoyancy improves transport properties of the slugs 34 and/or reduces their settling rates during placement and/or in shut-in conditions after job completion.

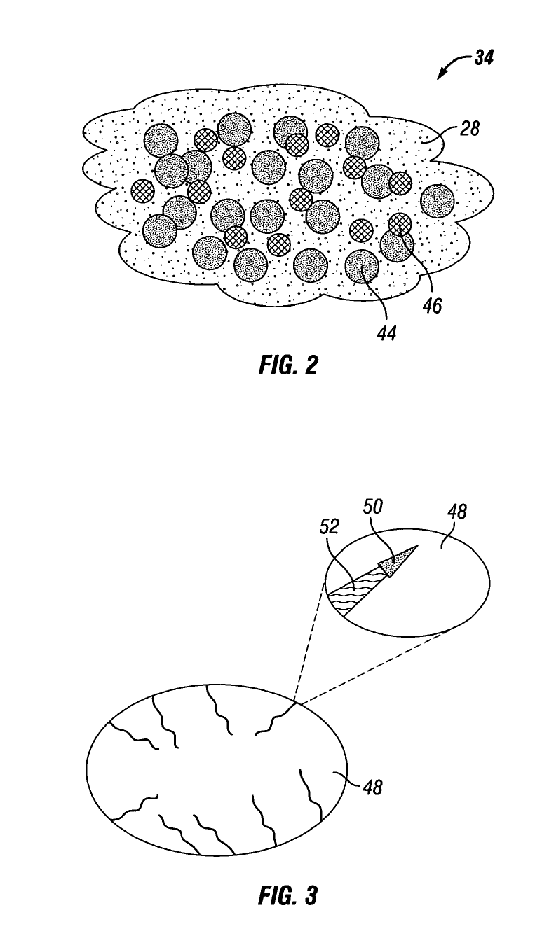

In other examples, the buoyancy controlling additive 46 utilizes highly porous materials with small pores containing air or other gases which make the material lightweight. Small pore size decreases or even removes the detrimental effect of the high hydrostatic pressure utilized in the fracturing process on the density of such porous, gas containing materials. This happens because the gas is compressed in the pores when the hydrostatic pressure of the fracturing fluid (in which the porous material is inserted) is increased, thus also increasing the apparent density of such material. If the surface properties of the pores make the contact angle of the liquid larger than 90 degrees on the pore surface, than the pressure in the gas phase will be lower (C.f. capillary pressure effect) than in the liquid phase. This pressure decrease becomes even more pronounced at small pore diameters. Hence, the undesired increase of the apparent density of the porous material resulting from the hydrostatic pressure increase of the liquid can be mitigated when the pore diameter is sufficiently low and the contact angle is sufficiently high. In these cases, the pore volume does not fully fill with liquid even under high liquid pressures. As illustrated in FIG. 3, the additive 46 may be formed of a porous material 48 containing gas 50, e.g. air. Under high hydrostatic pressure, the gas 50 is compressed but the pore space is not fully filled by a liquid 52.

In other embodiments, the buoyant or partially buoyant pillars may be formed with liquids or gases. For example, the buoyancy controlling additive 46 may comprise a liquid having a lower density than the clean fluid 30 and/or the proppant 44. For example, different types of oils may be used as the liquid, buoyancy controlling additive 46. The oil-based additive 46 may comprise liquid hydrocarbon (e.g. benzene, toluene, heptane, hexane or other liquid hydrocarbons or combinations), vegetable oil (e.g. sunflower oil, olive oil, palm oil, corn oil or any other vegetable oil or a combination of these oils), animal fat/oil, natural crude oil comprising produced oil, artificial product of crude oils comprising gasoline, kerosene, diesel fuel, and/or other artificial products. The liquid additive 46 also may comprise a chemically altered vegetable oil or animal fat/oil (e.g. white oil-in-water emulsion or kerosene containing hydrophobic sand). Various combinations of these liquid buoyancy controlling additives also may be used depending on the specifics of an application and the available materials.

Other embodiments of the buoyancy controlling additive 46 utilize additive in the form of a gas, e.g. N₂, CO₂, natural gas, methane, ethane, propane, or mixtures. The gas may be used as the light weight buoyancy controlling additive 46 by dispersing it in the supporting matrix/gel 28 at an operationally feasible content. If gas is used as the buoyancy controlling additive 46, appropriate consideration is made with respect to its variable density dependent on P-T conditions of the fracturing fluid.

Another example of buoyancy controlling additive 46 comprises hollow fibers employed as the lightweight buoyancy controlling additive. The hollow fibers are added to the supporting matrix/gel 28 to reduce the effective specific gravity of the slugs 34. The geometry (e.g. length) of fibers is chosen so as to reduce the potential for slugs 34 to bridge perforations or fractures.

Another approach comprises using cross-linked gel 28 integrating proppant particles as the light weight buoyancy controlling additive 46. Cross-linked gel can have specific gravity of 0.5-1.5. Additionally, gel 28 may comprise a variety of cross-linked gels including, guars and guar derivatives (e.g. hydroxypropyl guar, CMHPG or other derivatives), celluloses and cellulose derivative cross-linked gels, xanthan cross-linked gels, and/or other cross-linked gels. The cross-linked gels also may contain gel pieces as inclusions which are not cross-linked. When proppant particles are included in the supporting matrix of cross-linked gel, the specific gravity of the slugs 34 is lower than the specific gravity of proppant particles themselves. This can increase transportability of the proppant and decrease its settling rate as illustrated in the comparison below:

Comparison of specific gravities of Badger sand and guar cross-linked gel with different sand loadings:

| | | 25 ppt Guar | 25 ppt Guar gel + Badger Sand | | | | | | | |
|---|---|---|---|---|---|---|---|---|---|---|
| | Badger | cross-linked | 1 | 2 | 3 | 4 | 5 | 6 | 7 | 8 |
| Slug | sand | gel | ppa | ppa | ppa | ppa | ppa | ppa | ppa | ppa |
| SG | 2.65 | 1.01 | 1.08 | 1.15 | 1.21 | 1.26 | 1.31 | 1.36 | 1.40 | 1.45 |

In many applications, the viscosity of the gel 28, e.g. cross-linked gel, is at least 100 cP at bottomhole conditions. This enables the gel supporting matrix to keep components together at bottom hole pressure-temperature conditions until the fracture closure, thus preventing fallout of the proppant and the creaming of the lightweight buoyancy controlling additive while increasing the effectiveness of the treatment.

Additionally, various additives may be used in the clean/low viscosity fluid 30. For example, fibers may be added into the clean fluid 30 to enhance transportability of slugs 34 and to decrease the settling rate of the slugs 34 during and after completion of the well treatment job. The fibers may have a variety of sizes and shapes and may comprise soft fibers, rigid fibers, straight fibers, wavy/curled fibers, mixtures of fibers, or other suitable types of fibers or combinations of fibers. In some applications, the fibers may have special finishing or may be formed in multiple layers of similar or different materials. The properties of the fibers may be adjusted to limit the potential for bridging in the perforations, fractures, and/or treatment equipment. The clean fluid 30 may be a low viscosity fluid mixture comprised of at least water. In some applications, the clean fluid 30 comprises slick water. However, a variety of additional additives may be added to create the desired clean fluid 30. Examples of such additives include various salts, e.g. calcium chloride, potassium chloride, and other suitable salts, polymers, e.g. guar, polyacrylamide, CMC, and other suitable polymers, and/or fibers, e.g. non-degradable fibers and/or degradable fibers formed of materials such as polylactic acid, glass, or other suitable materials. The viscosity of clean fluid 30 may vary, but in many applications the clean fluid 30 is a low viscosity fluid having a viscosity less than 100 cP.

Fibers and/or particles also may be used in gel 28. For example, if cross-linked gel matrix 28 is used for integration of proppant particles 44 with buoyancy controlling additives 46, the process of slug preparation may include preparation of a linear gel with further cross-linking. The cross-linking additive used to create slugs 34 may contain cross-linking chemical agents, e.g. agents based on B³⁺, Ti⁴⁺, Zr⁴⁺, Al³⁺ ions and/or other suitable ions, and pH activators, e.g. NaOH, buffers, and/or other suitable pH activators. In some applications, the gel 28 may comprise cross-linked guar or its derivatives.

If guar or its derivatives are cross-linked by boron and used as the supporting matrix and if the pH of the cross-linked gel integrating matrix and the concentration of cross-linking chemical agents in the cross-linked gel are different from the pH of the clean fluid and the concentration of cross-linking chemical agents in the clean fluid, respectively, addition of diffusion control chemicals may be used to prevent diffusion of both the pH activator and the cross-linking chemical agents from the cross-linked gel integrating matrix 28 into the clean fluid 30. Otherwise, the dirty slugs 34 may lose their integrity and the low and high density components of the dirty slugs 34 could be spontaneously separated prior to fracture closure. As a result, the slug components are released out of the dirty slug 34 and the proppant is placed improperly along the fractures 36. In another embodiment, the period of immiscibility or the period of partial miscibility with the clean slug could be detrimentally reduced.

Various parameters of the clean, low viscosity fluid 30 may be adjusted to limit break down of the slugs 34. For example, additives may be combined with the low viscosity fluid 30 to adjust the pH of the low viscosity fluid 30 and/or to adjust a concentration of cross-linking ions in the low viscosity fluid 30. In an example, a diffusion control additive comprising B³⁺ ions is added into the clean fluid 30, and the additive prevents diffusion of B³⁺ ions of cross-linking agents from the cross-linked gel 28 into the low viscosity fluid 30. In another approach, diffusion control additives comprise NaOH, KOH, other suitable buffers containing these compounds (and combinations thereof. The diffusion control additives also may comprise both B³⁺ and NaOH, KOH, other buffers containing these additives (and combinations thereof).

If gel 28 is cross-linked by boron and used for treating the subterranean formation 24, diffusion control additives may be added into the clean fluid in such a way to adjust, e.g. equilibrate, pH in the cross-linked gel supporting matrix 28 and in the clean fluid 30. In another embodiment gel 28 is similarly cross-linked by boron and used for treating of subterranean formation 24. In this latter embodiment, diffusion control additives are added into the clean fluid 30 to prevent diffusion of cross-linking chemical agents from the cross-linked gel supporting matrix 28 into the clean fluid 30. Diffusion control additives also may be added into the clean, low viscosity fluid 30 to adjust, e.g. equilibrate, pH in the cross-linked gel supporting matrix 28 and in the clean fluid 30; and to prevent diffusion of the cross-linking chemical agents from the cross-linked gel supporting matrix 28 into the clean fluid 30.

Another approach employs a combination of cross-linkers to increase the viscosity of the slugs 34. In this example, inhibitor additives are added to the gel 28 to selectively retard action of one of the cross-linking agents. For example, if dual B—Zr cross-linker is used, some complexes can be added to the fluid to retard action of the Zr based cross-linker. This would facilitate creation of shear insensitive slugs as the slugs travel from the surface down to the perforations 38 and past these perforations. Subsequently, however, the Zr-based fluid would further cross-link the supporting matrix and it would yield P-T stable support members inside the fractures 36.

Another approach is to add special compounds to the gel prior to cross-linking of the gel to enhance the viscosity and shear stability of cross-linked slugs and to possibly induce the formation, separation, segregation, precipitation of a highly viscous phase if desired. Such compounds may include counter-charged compounds compared to the base polymer or other compounds which are able to form covalent bonds with the base polymer while still allowing cross-linking. The list of compounds includes, but is not limited to, cationic or anionic co-polymer of polyacrylamide, polyDADMAC, polyethyleneimine, quaternary ammonium salts, chelating agents, and/or other suitable compounds.

In another embodiment, additives may comprise pH modifiers employed to control the location where cross-linking of the supporting matrix occurs. For example, if some Zr based cross-linker contains Zr complex as cross-linking agent, this cross-linker does not cross-link guar or CMHPG at ambient temperature T until a suitable amount of alkaline is added to it. If alkaline is added, the pH increases, thus leading to cross-linking of the fluid. Otherwise, the guar or CMHPG cross-linking would occur at a higher temperature.

In some cases, particles of light weight buoyancy controlling additives 46 can be used to cross-link linear gel. For example, addition of 3M® hollow glass particles (3M® HGS product) to a guar gel 28 leads to cross-linking of this gel. If 3M® particles are added directly to the guar gel it can be difficult to obtain homogeneous slugs. Some lumps of hollow glass beads may be observed. However, this issue may be avoided by addition of cross-linking delay agent, e.g. sorbitol, to the gel before addition of the glass particles. By way of example, the cross-linker may be added at the final stage of slug preparation. Slugs 34 prepared in this manner tend to be homogeneous which positively affects slug stability. In another example, the cross-linking delay agent may be added into the linear gel before addition of the proppant 44 and buoyancy controlling additive 46 to reduce or prevent premature cross-linking of the gel which could otherwise be caused by the buoyancy controlling additive 46.

In another embodiment, surfactants may be used to increase stability of the slugs 34 if the buoyancy additive 46 has a poor affinity to the supporting matrix. In many embodiments discussed herein, the propping agents 44 can represent many types of fracturing propping agents, e.g. sand, ceramics, proppant (ISP, LWP, HSP, ULWP, non-API “junk” sand), and various combinations of proppant material. The proppant 44 also can be selected with several mesh sizes, e.g. 12/20, 16/30, 20/40, 30/50, 40/70, 70/140, and various combinations of sizes.

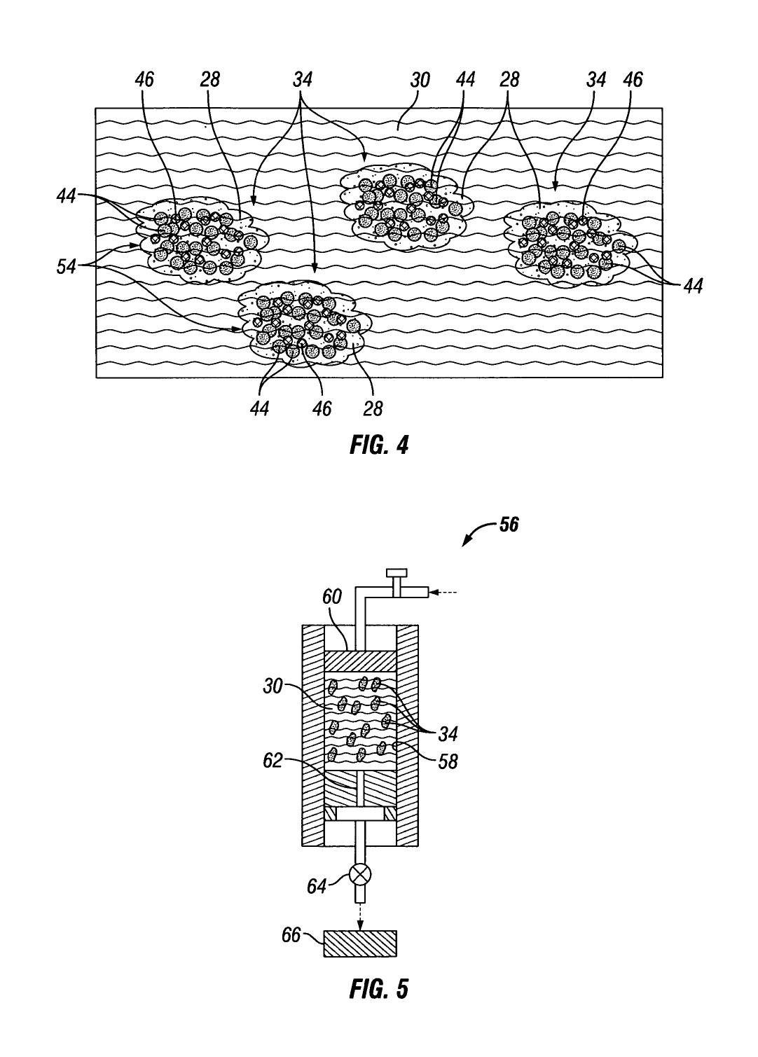

The various described combinations of supporting matrix 54, lightweight buoyancy controlling additive 46, and proppant 44 are designed to provide an effective specific gravity of slugs 34 which is lower than the specific gravity of proppant 44. Proppant laden slugs 34 with reduced specific gravity are transported by clean fluid 30 deeper into the created subterranean fractures 36 as compared to individual proppant grains dispersed in clean fluid. The proppant laden slugs 34 can be transported into the secondary and tertiary fractures as well. As discussed above, the slugs 34 have a reduced sedimentation rate as compared to the sedimentation rate of individual proppant grains. This enables the buoyant or partially buoyant slugs 34 to be suspended for longer period of time, which can extend to the time of fracture closure. As illustrated in FIG. 4, the gel 28 is separated into a plurality of the slugs 34 and carried by the low viscosity, clean fluid 30, e.g. slick water. The slugs 34 are maintained during transport via a supporting matrix 54 formed of the gel 28 and, for example, a variety of additives.

In many applications, the clean fluid 30 is a low viscosity fluid used to create a complex fracture network or one or more fractures in a subterranean formation. Proppant particles 44 may be integrated with buoyancy controlling additive 46 to promote transport of the proppant during the job and to reduce the settling rate after job completion. The supporting matrix 54 may comprise cross-linked gels and/or other high viscosity fluids. The supporting matrix 54 also may comprise additives, such as fibers, viscoelastic fluid, fluid with yield stress, and combinations of various additives. In many applications, the supporting matrix 54 comprises gel 28 having these additives individually or in combination. The clean fluid 30 may be in the form of a low viscosity fluid, e.g. water or slick water. The low viscosity fluid also may comprise additives, such as fibers. The buoyancy controlling additives added to gel 28 or to other materials forming supporting matrix 54 may comprise solids, e.g. porous, hollow, and/or clathrates type solids; liquids, e.g. oils, cross-linked gels; gases; and/or various combinations of additives.

In some embodiments, gel 28 is a cross-linked gel used to form the supporting matrix 54. In this example, diffusion controlling additives may be added into the clean fluid 30 to maintain stability of the slugs 34. For example, a variety of additives may be used in the clean fluid 30 to maintain stable slugs 34 if boron is used for the cross-linking. Examples of diffusion controlling additives include pH controlling agents, cross-linking chemical agents, and combinations of pH control agents and cross-linking chemical agents. Additionally, a pH modifier may be employed to control conditions at which cross-linking can happen to avoid premature or late cross-linking of the slugs 34. Chemicals also may be used to control a sequence of cross-linking action if a combination of cross-linkers is employed. In some applications, a cross-linking additive is added to the gel intermittently to create independent cross-linked slugs 36. It should be noted that some buoyancy control additives 46 also may have a capacity to cause cross-linking of the gel 28. In this latter example, a cross-linking delay agent may be added prior to addition of the buoyancy controlling additive 46.

The formation of slugs 34 and the maintenance of slugs 34 while carried by clean fluid 30, e.g. a low viscosity fluid, enhances a variety of fracturing related well treatments. The methodology provides an improved transport of proppant 44 and greater vertical coverage within the fractures 36. Additionally, enhanced propping of fractures occurs because the proppant is carried farther without settling. The improved proppant placement increases conductivity of the formation and thus production of the well. Additionally, the amount of proppant, e.g. sand, used to prop the formation can be decreased due to the improved placement. Compared to a variety of conventional gel treatments, the methodology provides better complexity of fractures and reduced gel usage. For example, the approach can reduce the amount of guar used for a given well treatment.

A variety of testing was performed to verify the enhanced well treatment capability of transporting slugs in a clean fluid, as described herein. The following examples represent various testing procedures performed with a variety of matrix/gel materials and clean fluid materials.

### Example 1

### Light Slugs

Accordingly to embodiments disclosed herein, slugs 34 were prepared with different buoyancy controlling additives. In this example, two slugs were initially prepared. One slug contained 4 PPA (PPA-mass of an additive (lbm) added into clean fluid (1 US gal)) of Badger 100-mesh sand in guar 40 ppt (ppt-mass of an additive (lbm) added into clean fluid (1000 US gal)) crosslinked gel; and another slug contained 4 PPA of Badger 100-mesh sand and 4 PPA of hollow ceramic microspheres (light weight buoyancy controlling additive, SG≈0.65-0.85) in guar 40 ppt cross-linked gel. Both slugs were dropped into two plastic cups which contained 4% KCl brine each. The slug containing the hollow ceramic microspheres as a light weight buoyancy controlling additive was found to be floating on the surface of the brine while the other slug sank.

Furthermore, three other types of light weight buoyancy controlling additives (3M® HGS, oil and gas) were used for preparation of slugs 34. The slug containing 3M® HGS was obtained by gradually adding of 0.6 PPA of HGS10000 (hollow glass spheres from 3M® with SG=0.6 and pressure resistance of 10,000 psi) and 0.75 PPA of Badger 100-mesh sand to the linear guar gel (25 ppt) during constant mixing. The addition of cross-linker can be omitted in this case because the selected additive, i.e. hollow glass spheres containing boron, effectively cross-linked the gel without added cross-linker.

The oil containing slug 34 was obtained by rapid mixing of 25 ppt guar gel with 2 gpt (gal of additive added to 1000 gal of clean fluid) of emulsifier and 3.2 PPA of sunflower oil (SG=0.9). Then 0.75 PPA of Badger 100-mesh sand was added during the intensive mixing period and after that 2 gpt of boron-based cross-linker was quickly injected to this mixture.

The gas containing slug 34 was prepared by mixing of 25 ppt guar gel with 100 gpt of foaming agent SDS (0.13 M) in a blender. The volume of produced foam was about 5 times more than initial volume of the linear gel. Then 0.75 PPA of Badger 100-mesh sand was gradually added to the gas dispersion during the mixing. After that, the gas dispersion was cross-linked by 2 gpt of boron-based cross-linker. Finally a slug containing approximately 0.02 PPA of air was obtained. In these glass microsphere, oil, and gas examples, each of the obtained slugs 34 was able to float in a cup containing tap water.

### Example 2

### Lightweight Buoyancy Controlling Additive does not Cross-Link Dirty Fluid

Slugs 34 were created with 3M® hollow glass spheres used as light weight additive for controlling buoyancy. The slug was obtained by different methods.

In the first method Guar gel 25 ppt was prepared; 1 ppa of 100 mesh Badger sand was added; and subsequently 0.5 ppa of HGS 8000× was added directly to the mixture. The gel started to cross-link itself, however certain difficulties related to mixing of components were observed. The obtained slug was not entirely homogeneous and some lumps of hollow glass bubbles were observed.

In the second method, 1 ppa of 100 mesh Badger sand was added to 25 ppt Guar Gel and subsequently delay agent with sorbitol as the basic acting agent was added into the blend. 0.5 ppa of HGS 8000× were added afterwards. No cross-linking was observed and the fluid remained thin. Subsequently, 2 gpt of boron-based cross-linker was added. When the gel cross-linked, a very homogeneous slug was obtained. No mixing issues were observed during the slug preparation.

### Example 3

### Increased Stability of the Slug Prepared with Delay Agent

During a well treatment job, the slugs 34 can experience very high shear rates while passing through, for example, the well equipment, the casing, and the perforations. This shear force can destroy or otherwise detrimentally affect the slugs 34, leading to proppant fall-out and improper proppant placement. The impact of slug preparation on the ability of the slug to withstand shear stress has been examined with a special cell, illustrated in FIG. 5. The ability of the slugs to remain intact at high shear rates was tested in the cell with a narrow cell passage (2×46×50 mm) at the bottom of the cell. As illustrated in FIG. 5, a cell 56 has an interior 58 filled with a plurality of slugs/pillars 34 disposed in low viscosity fluid 30 such as water. Pressure is applied to the mixture by a piston 60, and the mixture is forced through the narrow cell passage 62 at the bottom of the cell 56 to create a high shear rate region. A bottom valve 64 may be used to control flow of the mixture into a vessel 66, as illustrated.

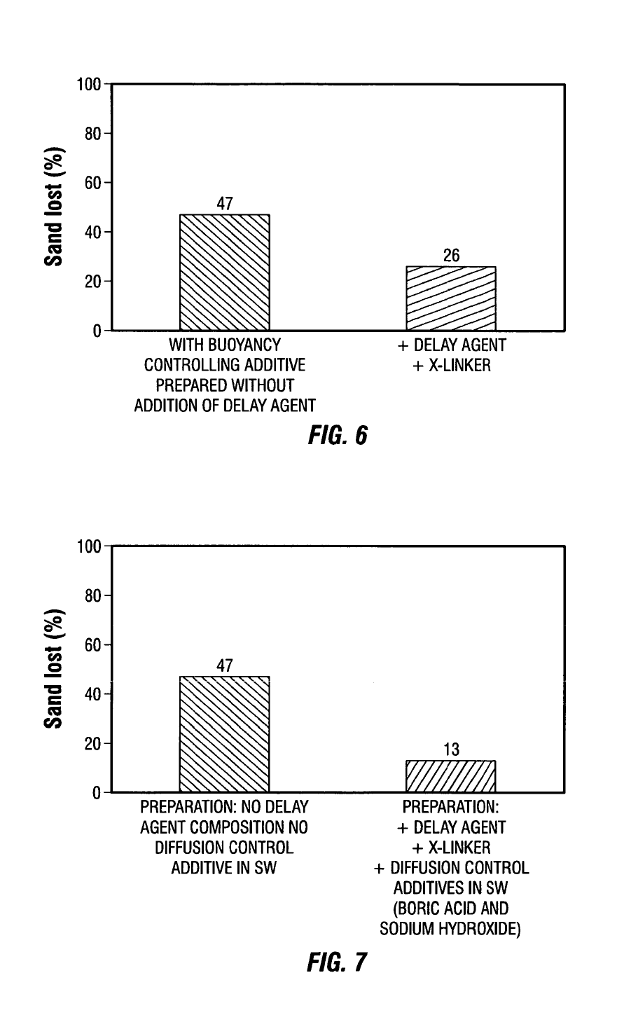

A pressure drop of 100 psi was applied to create shear rates close to or higher than actual shear rates experienced in the real world environment. The proppant, e.g. sand, separated out of the proppant slug and was collected after the test. The proppant was dried and its mass was measured. The percentage of sand separated from the slugs is presented graphically in FIG. 6. From FIG. 6, one can conclude that if the slug is prepared with delaying agent the amount of proppant/sand falling out of the slug is almost two times less than the case when the slug is prepared without adding delaying agent. Consequently, a conclusion may be made that the method of preparation has a substantial impact on stability of the slugs 34. Addition of delay agent prior to addition of hollow glass spheres results in obtaining a homogeneous slug. The slug components are uniformly distributed inside the cross-linked gel matrix. If cross-linking delay agent is not added into the gel before addition of glass bubbles, premature cross-linking of the gel can result. The premature cross-linking creates difficulties with respect to uniformly distributing components within the gel, and lumps of glass bubbles may be observed. This inhomogeneity leads to reduced survivability of the slugs when shear force is applied.

### Example 4

### Addition of Diffusion Control Additives into the Clean Fluid Increases Stability of the Slugs

The impact of composition of the clean fluid on slug stability has been investigated in a manner similar to that described above in Example 3. Results are presented in FIG. 7, which illustrates that addition of diffusion control agents into the clean fluid 30 substantially increases stability of the slugs 34. The stability of slugs 34 at static conditions was checked as well. In this example, slugs were kept for 3 hours in clean fluids with different compositions and the amount of sand separated was measured for each case. Results of the slug stability tests at static conditions in different media are presented as follows:

| Clean fluid | pH | Sand fallen out, % |
|---|---|---|
| Tap water | 7.4 | 100 |
| Slickwater | 7.6 | 95 |
| Tap water with pH control | 10.5 | 7 |
| additive NaOH/Na₂CO₃ | | |
| Tap water with H₃BO₃ and | 11.8 | 0 |
| NaOH | | |

From the results above, it can be recognized that the slug was much more stable when a pH regulator additive was introduced into the clean fluid 30. The amount of separated proppant, e.g. sand, decreased dramatically. When a chemical additive containing both pH regulator and cross-linking ion was introduced to the clean fluid 30, no sand fallout from the slug was measured after 3 hours.

### Example 5

### Impact of pH on the Cross-Linking of Gels with Zr-Based Cross-Linker

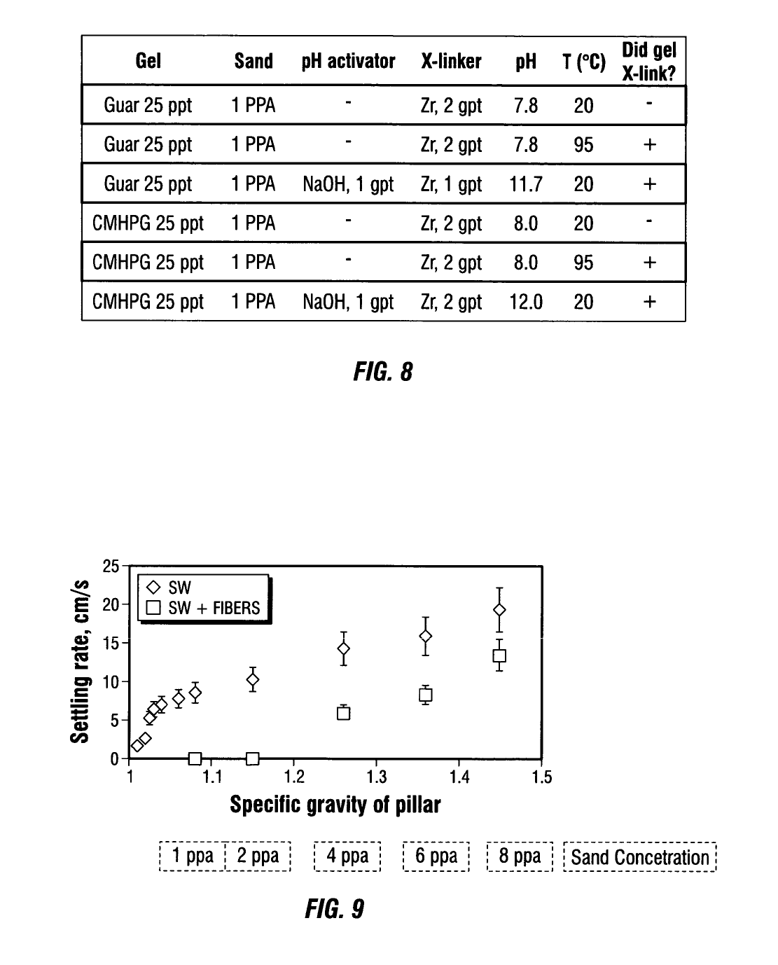

In this example, two different gels were tested, namely Guar and CMHPG. Additionally, a Zr based cross-linker was used. The impact of pH on the performance of cross-linker at ambient conditions was tested. The results of the testing have been presented in the table illustrated in FIG. 8. In this example, (30 wt % of NaOH solution) was used as a pH modifier. From the data presented in FIG. 8, one can conclude that the pH of the liquid has substantial impact on the temperature at which Zr based cross-linker can act. From this data, it is apparent that alkaline decreases the acting temperature substantially.

### Example 6

### Improved Increased Performance in Comparison with Slick Water Treatment: Increased Proppant Vertical Coverage

If proppant, e.g. sand, is delivered into the fractures in the form of slugs and stays there in the form of slugs, a substantial increase of propped area is achieved even if the slugs accumulate in the bottom of the fractures as compared to slick water treatment. In this example, a visual comparison of propped area resulting from slick water treatment was performed. However, the formation of slugs according to the methodology described herein increased the proppant area by 4-6 times. The use of buoyant or light slugs increased the propped area by 10 times and the slugs were distributed along the height of the fracture. The same amount of proppant/sand was used in all cases.

Additionally, the methodology described herein enables creation of propped secondary and tertiary fractures which is unlikely with conventional slick water treatments. It was observed that proppant laden slugs can easily turn the corners along the fractures. For example, slugs were able to pass through a complex fracture network having: 10 mm→2 mm→5 mm fractures. In this experimental example, the parameters were as follows: clean fluid—tap water with flow rate of 30 l/min, pillar contains 0.75 ppa of 100 mesh Badger sand and 0.6 ppa of 3M® HGS10000, guar loading 15 ppt.

### Example 7

### Fibers Increase Performance of the Product: Retard Settling of the Slugs in Shut-in

The settling rate of slugs using Badger sand in cross-linked guar gel was investigated by means of cylinder tests in slick water and slick water containing 20 ppt of fibers made of polylactic acid (PLA). In this example, the presence of fibers in the clean fluid was observed to substantially decrease settling rates of proppant laden slugs, as illustrated in FIG. 9. The example provided a comparison of settling rates of proppant laden slugs with different sand concentrations in the slick water media and in the slick water with 20 ppt of fibers media. The volume of the slug was equal to 1.5 cc.

To verify the ability of fibers dispersed in the clean fluid to mitigate or prevent settling of the slugs, another test was performed with a large slot manifold. The impact of fibers on the settling rate of the slugs was observed as reducing the settling rate of the slugs. The composition of the slugs in this experiment was: 18 ppt Guar gel, 2 ppa 100 mesh Badger sand SG of the slugs=1.15. The clean fluid used was slick water with diffusion control additives. The fibers were PLA fibers 20 ppt. The slot width through which the slugs were passed was 2 mm, and the walls of the manifold in which the slots were formed were smooth. The observed results of this test enables one to conclude that addition of fibers into the clean fluid can substantially mitigate settling of proppant slugs and thus increase the vertical coverage of the fracture with proppant while promoting creation of channels between the slugs.

### Example 8

### Possible Ways of Well Site Delivery (WSD) for the Fracturing Method Described Herein

An option for well site delivery of proposed fracturing method is a split stream approach. The split stream approach utilizes two simultaneous flows of the both clean fluid 30 and dirty fluid 28. For example, slick water and proppant-laden fluid may be supplied simultaneously to the separate HP pumps 32 (pump 1 and pump 2) and mixed downstream of the pumps. Slugs 34 are generated at the point where the two streams are combined, and then slugs are further sheared into smaller slugs 34 at perforations 38. However, a variety of other well site delivery systems and layouts may be utilized.

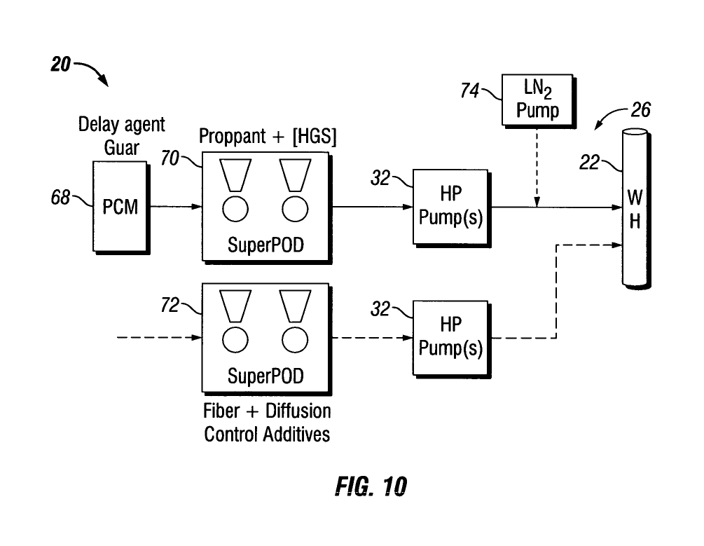

An example of the split stream fracturing equipment layout is illustrated in FIG. 10 and utilizes at least one frac tank, e.g. a plurality of frac tanks, storing water or other low viscosity clean fluid. In this example, the fracturing equipment layout further comprises a PCM (precision continuous mixer) 68 which serves as an on-the-fly linear gel mixer. The layout further comprises a SuperPOD 70 which enables precise dosing and mixing of fracturing sand/proppant with linear gel and any other additives. A SuperPOD 72 may be used to mix fiber and/or diffusion control additives with the clean water 30. A centrifugal pump (C-pump) may be used to transfer the low viscosity clean fluid, e.g. water. The high pressure pumps 32 are configured to deliver the resulting slurry at high pressure to the subterranean formation. A pump 74 may be used to inject a suitable additive (e.g. LN₂) or additives into the gel 28.

### Example 9

### Addition of Counter-Charged Compounds Prior to Guar Cross-Linking to Improve Shear Stability

In this example, a linear gel solution contains 15 lbm/1000 gal of guar gum, 2 wt % of KCl, and 1 lbm/gal of Badger 100-mesh sand. One portion (portion 1) of the solution was cross-linked by addition of the following chemicals in the listed order: 11 lbm/1000 gal of boric acid followed by 3 gal/1000 gal of 10 wt % sodium hydroxide. The second portion (portion 2) was linear gel cross-linked by addition of the following chemicals in the following order: 3 gal/1000 gal of polyethyleneimine, 11 lbm/1000 gal of boric acid, followed by 3 gal/1000 gal of 10 wt % sodium hydroxide. Approximately 150 mL of each portion was dropped inside 150 mL of water and placed inside the device/cell 56 illustrated in FIG. 5. A pressure differential of 100 psi was applied to each portion as each portion was rapidly squeezed through a 6 mm hole. The amount of sand smaller than 40-mesh size was then measured. In this example, 10% of sand smaller than 40-mesh sieve was separated from portion 1, and 8% of the sand was separated from portion 2.

However, the well treatment technique may utilize a variety of gels, including cross-linked gel and other materials, e.g. fluids, suitable to contain proppant. For example, a fluid having a viscosity of at least 100 cP measured at 100 sec⁻¹ at bottomhole static temperatures may be used to contain the proppant instead of cross-linked gel. Specific examples of other types of fluids/gels comprise VES-based fluids, gelled oils, polymer containing fluids, foamed fluids, energized fluids, acids, other polymer or surfactant-based fluids, high solid content fluids, or other suitable fluids/gels.

The well treatment technique also may utilize a variety of equipment types arranged in various layouts to create the desired slugs and clean fluid for carrying the slugs into the formation. Numerous types of pumps, injectors, mixers, slug formation devices, and/or other devices may be incorporated into the overall system. Similarly, many types of fluids may be used to create the gel or other support matrix for carrying the proppant in independent slugs to the desired formation location. Various fluids also may be used to create the clean fluid, e.g. low viscosity fluid, employed to transport the slugs. As described above, many types of additives may be added to the gel, clean fluid, or other material to form and maintain the slugs when carried by the clean fluid. For example, many types of additives may be used with the clean fluid to facilitate the desired well treatment. Additionally, various fluid parameters of the gel and/or the low viscosity fluid may be adjusted to facilitate maintenance and transport of the slugs to desired locations. Various surfactants or combinations of surfactants may be used when combining a gel containing proppant with a fluid, e.g. a low viscosity fluid. A variety of buoyancy additives may be added to the slug forming material to create slugs with the desired buoyancy.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A method for well treatment, comprising:
injecting a cross-linked gel containing proppant into a wellbore extending into a subterranean formation:
injecting a low viscosity fluid into the wellbore;
separating the cross-linked gel into slugs at a downhole location;
adjusting at least one specified parameter of the low viscosity fluid to limit breakdown of the slugs; and
placing the low viscosity fluid and the slugs under pressure into fractures formed in the subterranean formation, thus enabling distribution of the slugs in a manner which forms proppant pillars.

2. The method as recited in claim 1, wherein adjusting comprises adjusting the pH of the low viscosity fluid.

3. The method as recited in claim 1, wherein adjusting comprises adjusting at least the concentration of cross-linking ions in the low viscosity fluid.

4. The method as recited in claim 1, wherein injecting the low viscosity fluid comprises injecting slick water or linear gel having a viscosity less than 10 cP measured at 100 sec⁻¹ shear rate at bottomhole conditions.

5. The method as recited in claim 1, wherein injecting the low viscosity fluid comprises injecting slick water or linear gel having a viscosity less than 100 cP measured at 100 sec⁻¹ at bottomhole conditions.

6. The method as recited in claim 1, further comprising adding fibers to the low viscosity fluid to reduce settling of the proppant laden slugs in the subterranean formation.

7. The method as recited in claim 1, wherein injecting the cross-linked gel comprises injecting cross-linked gel having a viscosity of at least 100 cP measured at 100 sec⁻¹ shear rate at bottomhole conditions.

8. The method as recited in claim 1, wherein injecting comprises injecting the cross-linked gel in a form comprising compounds counter-charged compared to a base polymer.

9. The method as recited in claim 1, wherein injecting comprises injecting the cross-linked gel in a form comprising compounds which can form covalent bonds with a base polymer while still allowing cross-linking.

10. The method as recited in claim 1, wherein injecting comprises injecting the cross-linked gel in a form comprising at least one of cationic or anionic co-polymer of polyacrylamide, polyDADMAC, polyethyleneimine, quaternary ammonium salts, and chelating agent.

11. The method as recited in claim 1, further comprising increasing the buoyancy and reducing the specific gravity of the cross-linked gel by adding gas, oil, or hollow material to the cross-linked gel.

12. The method as recited in claim 1, further comprising mixing the cross-linked gel and the low viscosity fluid at a wellhead.

13. A method for well treatment, comprising:
injecting a gel containing proppant into a wellbore extending into a subterranean formation;
injecting a low viscosity fluid into the wellbore with the gel;
while injecting the gel and the low viscosity fluid, intermittently adding a cross-linking additive to the gel to create independent cross-linked slugs; and
placing the independent cross-linked slugs and the low viscosity fluid into fractures in the subterranean formation to form proppant pillars.

14. The method as recited in claim 13, wherein injecting the low viscosity fluid comprises injecting a mixture comprised of at least water.

15. The method as recited in claim 13, further comprising adjusting at least one of a concentration of cross-linking ions in the low viscosity fluid or a pH of the low viscosity fluid.

16. The method as recited in claim 13, further comprising increasing the buoyancy of the cross-linked gel.

17. The method as recited in claim 13, further comprising mixing a buoyancy controlling additive with the gel to facilitate transport of the slugs into the fractures by the low viscosity fluid.

18. A method for well treatment, comprising:
combining a gel containing proppant with a low viscosity fluid having a viscosity less than 100 cP measured at 100 sec⁻¹ shear rate at bottomhole conditions;
using an additive to maintain the gel in the low viscosity fluid;
adjusting the buoyancy of the gel;
separating the gel into slugs; and
flowing the slugs into fractures in a subterranean formation.

19. The method as recited in claim 18, wherein combining comprises using gel having viscosity of at least 100 cP measured at 100 sec⁻¹ shear rate at bottomhole static temperature.

20. The method as recited in claim 18, wherein combining comprises using gel in the form of a cross-linked gel in which the gel comprises guar, or its derivatives HPG or CMHPG, cross-linked by a cross-linking chemical agent based on at least one of B³⁺, Ti⁴⁺, Zr⁴⁺, Al³⁺ ions, and NaOH, KOH, buffers, and other suitable pH activators.

21. The method as recited in claim 18, wherein combining comprises using surfactant or a combination of surfactants.
